(19) United States
(12) Patent Application Publication
(10) Pub. No.: US 2014/0275516 A1
(43) Pub. Date: Sep. 18, 2014

(54) NATURALLY DERIVED MIXED CELLULOSE ESTERS AND METHODS RELATING THERETO

(71) Applicant: Celanese Acetate LLC, Irving, TX (US)

(72) Inventors: Michael Combs, Pembroke, VA (US); Wendy Bisset, Eggleston, VA (US); Jonathan S. Lockhart, Christiansburg, VA (US)

(73) Assignee: Celanese Acetate LLC, Irving, TX (US)

(21) Appl. No.: 14/206,383

(22) Filed: Mar. 12, 2014

Related U.S. Application Data
(60) Provisional application No. 61/781,851, filed on Mar. 14, 2013.

(51) Int. Cl. C08B 3/06

(52) U.S. Cl. CPC C08B 3/06
USPC 536/83; 536/69

(57) ABSTRACT

Mixed cellulose esters derived from natural products (e.g., natural cellulose esters) may be produced by methods that include acylating a cellulose with a natural esterification reactant or a derivative thereof to yield a natural cellulose ester. In some instances, the natural esterification reactant derivative may be a saponified natural esterification reactant. In some instances, the natural cellulose esters may have a glass transition temperature of about −55° C. to about 170° C.

### BACKGROUND

The present invention relates to mixed cellulose esters derived from natural products and methods relating thereto.

Cellulose esters, and most commonly cellulose acetate, are utilized in a plurality of applications including textile fibers, cigarette filter tips, plastics, films, and paints. In general, cellulose acetate is a semi-synthetic polymer obtained by esterification of cellulose (e.g., from wood pulp) using acetic anhydride and acetic acid. For higher carbon esters, higher carbon acids like propionic acid and butyric acid may be utilized.

Long-chain cellulose esters (e.g., greater than about 4 carbon chain length) have been of commercial interest because of their potential for improved processing properties and final product characteristics. For example, long-chain cellulose esters may have a lower melting point and increased solubility in less polar solvents. Further, once in a final product (e.g., a film after casting) the impact strength may be greater than for shorter-chain cellulose esters. However, long-chain cellulose ester synthesis typically utilize purified reactants that yield long-chain cellulose esters with some crystallinity (e.g., polysaccharide alignment), which lessens the degree to which the properties are effected. That is, with crystallinity, the melting point is not lowered as much, and the like for other properties.

### DETAILED DESCRIPTION

The present invention relates to mixed cellulose esters derived from natural products and methods relating thereto.

The present invention provides for, in some embodiments, mixed cellulose esters derived from natural reactants, e.g., a natural cellulosic source and natural esterification reactants (e.g., corn oil fatty acids). Natural esterification reactants may have a mixture of fatty acid carbon chain lengths, which may yield cellulose esters with decreased glass transition temperatures and lower melting temperatures. Without being limited by theory, it is believed that the mixed chain length of the esters may further inhibit polysaccharide crystallization, which may advantageously further decrease glass transition temperatures and lower melting temperatures as compared to the long-chain cellulose esters from purified versions.

Mixed cellulose esters derived from natural reactants may be particularly useful as melt-processable cellulose esters in adhesives, plastics, coating, films, and the like.

Further, the properties of the cellulose esters (e.g., glass transition temperature, melting point, and solubility) described herein may depend on the source or mixture of sources for the natural esterification reactants. Therefore, the properties of the cellulose esters may be tailored using mixtures of natural esterification reactants.

In addition, the cellulose esters described herein may have environmental benefits. For example, upon degradation, the cellulose esters may, at least in part, revert back to their natural reactants. Further, the use of natural esterification reactants may allow manufacturers to utilize waste streams of other manufacturing processes.

It should be noted that when “about” as used herein in reference to a number in a numerical list, the term “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

Some embodiments may involve acylating cellulose with a natural esterification reactant or derivative thereof. In some embodiments, acetylation may be performed by at least one of Fischer esterification, enzymatic esterification, acyl chloride esterification, activated acylation, and the like. Derivatives of natural esterification reactants may include saponified natural esterification reactants.

In some embodiments, the cellulose may be an underivatized cellulose or a derivatized cellulose (e.g., cellulose acetate). In some embodiments, the cellulose may be derived from a natural cellulosic source. Examples of natural cellulosic sources may include, but are not limited to, softwoods, hardwoods, cotton linters, switchgrass, bamboo, bagasse, industrial hemp, willow, poplar, perennial grasses (e.g., grasses of the Miscanthus family), bacterial cellulose, seed hulls (e.g., soy beans), recycled cellulose, and the like, and any combination thereof.

Examples of natural esterification reactants may include, but are not limited to, fatty acids extracted from vegetable and seed oils like corn, flaxseed, hemp, soy, canola, coconut, cocoa, palm, cottonseed, grape seed, almond, peanut, olive, and the like, and any combination thereof. Examples of the composition of fatty acids derived from natural sources are provided in Table 1. It should be noted that these are exemplary examples, the exact composition of a naturally derived fatty acid mixture may be different, e.g., depending on the exact source and extraction technique.

TABLE 1

| | | | | | | | Linoleic | Alpha |
|---|---|---|---|---|---|---|---|---|
| | Capric | Lauric | Myristic | Palmitic | Stearic | Oleic | Acid | Linolenic |
| Source | Acid | Acid | Acid | Acid | Acid | Acid | (ω6) | Acid |
| Coconut Oil | 6 | 47 | 18 | 9 | 3 | 6 | 2 | — |
| Cocoa Butter | — | — | — | 25 | 38 | 32 | 3 | — |
| Corn | — | — | — | 11 | 2 | 28 | 58 | 1 |
| (Maize) Oil | | | | | | | | |

In some embodiments, a mixture of two or more natural esterification reactants may be used in synthesizing natural cellulose esters described herein. In some embodiments, a natural cellulose ester described herein may comprise cellulose derivatized with a plurality of esters having varying carbon chain lengths. In some embodiments, the varying chain lengths may correspond to a chain length distribution of a natural fatty acid.

In some instances, the properties of the natural cellulose esters described herein may depend on, inter alia, the cellulosic source from which the natural cellulose esters are derived. Without being limited by theory, it is believed that other components, e.g., lignin and/or hemicelluloses, and concentrations thereof in the various cellulosic sources contribute to the different properties of the natural cellulose esters derived therefrom.

In some embodiments, the natural cellulose esters described herein may have a degree of substitution ranging from a lower limit of about 0.2, 0.5, or 1 to an upper limit of about 3, 2.7, 2.2, 2, or 1.5, and wherein the degree of substitution may range from any lower limit to any upper limit and encompass any subset therebetween. The degree of substitution may depend on, inter alia, the reaction pathway, the concentration of reactants (e.g., cellulose and natural esterification reactants), the compositions of the reactants, the reaction conditions (e.g., temperature, pressure, time, and the like), and the like, and any combination thereof.

In some embodiments, the natural cellulose esters described herein may have a glass transition temperature (e.g., as measured by DSC) ranging from a lower limit of about −55° C., −35° C., 0° C., 10° C., 30° C., 60° C., 80° C., or 100° C. to an upper limit of about 170° C., 150° C., or 130° C., and wherein the degree of substitution may range from any lower limit to any upper limit and encompass any subset therebetween. The degree of substitution may depend on, inter alia, the reaction pathway, the concentration of reactants (e.g., cellulose and natural esterification reactants), the compositions of the reactants (e.g., the composition of the natural esterification reactants), the properties of the reactants (e.g., the molecular weight of the cellulose), the reaction conditions (e.g., temperature, pressure, time, and the like), the cellulosic source, and the like, and any combination thereof.

In some embodiments, the natural cellulose esters described herein may have no true melting temperature. As used herein, the term “melting temperature” refers to the temperature at which polymer chains transition from a crystalline structure to a non-crystalline structure. That is, the crystallinity of the natural cellulose esters described herein may be so disrupted that a melting point may not be observable by differential scanning calorimetry (“DSC”).

In some embodiments, the natural cellulose esters described herein may be utilized in products like at least one of cellulose ester fibers, cellulose ester fiber tows, textile fibers, cigarette filter tips, plastics, films, molded articles, layered articles, cosmetics, paints, adhesives, and the like.

Embodiments disclosed herein include:

A: a method that includes acylating a cellulose with a natural esterification reactant or a derivative thereof to yield a natural cellulose ester;

B: a natural cellulose ester comprising cellulose derivatized with a plurality of esters having varying carbon chain lengths substantially corresponding to a chain length distribution of a natural fatty acid; and

C: a product comprising a natural cellulose ester of Embodiment B.

Embodiment A may have one or more of the following additional elements in any combination: Element 1: acylating is performed by at least one of a Fischer esterification, an enzymatic esterification, an acyl chloride esterification, and an activated acylation; Element 2: the derivative is a saponified natural esterification reactant; and Element 3: the natural esterification reactant comprising a fatty acid extracted from at least one selected from the group consisting of a vegetable, a seed, corn, flaxseed, hemp, soy, canola, coconut, cocoa, palm, cottonseed, grape seed, almond, peanut, olive, and any combination thereof.

Each of embodiments A, B, and C may have one or more of the following additional elements in any combination: Element 4: the natural fatty acid being extracted from at least one selected from the group consisting of a vegetable, a seed, corn, flaxseed, hemp, soy, canola, coconut, cocoa, palm, cottonseed, grape seed, almond, peanut, olive, and any combination thereof; Element 5: the cellulose being derived from a cellulosic source selected from the group consisting of a softwood, a hardwood, a cotton linter, switchgrass, bamboo, bagasse, industrial hemp, willow, poplar, a perennial grass, a bacterial cellulose, a seed hull, a recycled cellulose, and any combination thereof; Element 6: the cellulose being a cellulose derivative; Element 7: the natural cellulose ester has a degree of substitution of about 0.2 to about 3; Element 8: the natural cellulose ester has a glass transition temperature of about −55° C. to about 170° C.; and Element 9: the natural cellulose ester has no true melting temperature.

By way of non-limiting examples, exemplary combinations independently applicable to A, B, and C include: Element 1 in combination with at least one of Elements 2-3; Element 1 in combination with at least one of Elements 5-8; Element 4 in combination with Element 5; Elements 4 and 6 in combination with at least one of Elements 8-9; Elements 4 and 7 in combination with at least one of Elements 8-9; Elements 6 and 7 in combination with at least one of Elements 8-9; and so on.

To facilitate a better understanding of the present invention, the following examples of preferred or representative embodiments are given. In no way should the following examples be read to limit, or to define, the scope of the invention.

### EXAMPLES

### Example 1

Cellulose acetate was reacted with a variety of natural esterification reactants (Table 2) in the presence of trifluoroacetic anhydride. The natural esterification reactants were obtained from the corresponding oils through saponification, in some instances, neutralized to the acid before use.

TABLE 2

| | Natural Esterification | Glass Transition |
|---|---|---|
| Sample | Reactant | Temperature (° C.) |
| 1 | corn oil | −26.9 |
| 2 | cocoa butter oil | −36.6 |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

The invention claimed is:

1. A method comprising:
acylating a cellulose with a natural esterification reactant or a derivative thereof to yield a natural cellulose ester.

2. The method of claim 1, wherein acylating is performed by at least one of a Fischer esterification, an enzymatic esterification, an acyl chloride esterification, and an activated acylation.

3. The method of claim 1, wherein the derivative is a saponified natural esterification reactant.

4. The method of claim 1, wherein the cellulose is derived from a cellulosic source selected from the group consisting of a softwood, a hardwood, a cotton linter, switchgrass, bamboo, bagasse, industrial hemp, willow, poplar, a perennial grass, a bacterial cellulose, a seed hull, a recycled cellulose, and any combination thereof.

5. The method of claim 1, wherein the natural esterification reactant comprises a fatty acid extracted from at least one selected from the group consisting of a vegetable, a seed, corn, flaxseed, hemp, soy, canola, coconut, cocoa, palm, cottonseed, grape seed, almond, peanut, olive, and any combination thereof.

6. The method of claim 1, wherein the natural cellulose ester has a degree of substitution of about 0.2 to about 3.

7. The method of claim 1, wherein the natural cellulose ester has a glass transition temperature of about −55° C. to about 170° C.

8. The method of claim 1, wherein the natural cellulose ester has no true melting temperature.

9. An article comprising the natural cellulose ester produced by the method of claim 1.

10. A method comprising:
acylating a cellulose with a natural esterification reactant or a derivative thereof to yield a natural cellulose ester;
wherein the cellulose is derived from a cellulosic source selected from the group consisting of a softwood, a hardwood, a cotton linter, switchgrass, bamboo, bagasse, industrial hemp, willow, poplar, a perennial grass, a bacterial cellulose, a seed hull, a recycled cellulose, and any combination thereof; and
wherein the natural esterification reactant comprises a fatty acid extracted from at least one selected from the group consisting of a vegetable, a seed, corn, flaxseed, hemp, soy, canola, coconut, cocoa, palm, cottonseed, grape seed, almond, peanut, olive, and any combination thereof.

11. The method of claim 10, wherein the natural cellulose ester has a degree of substitution of about 0.2 to about 3.

12. The method of claim 10, wherein the natural cellulose ester has a glass transition temperature of about −55° C. to about 170° C.

13. The method of claim 10, wherein the natural cellulose ester has no true melting temperature.

14. A natural cellulose ester comprising: a cellulose derivatized with a plurality of esters having varying carbon chain lengths substantially corresponding to a chain length distribution of a natural fatty acid.

15. The natural cellulose ester of claim 14, wherein the cellulose is derived from a cellulosic source selected from the group consisting of a softwood, a hardwood, a cotton linter, switchgrass, bamboo, bagasse, industrial hemp, willow, poplar, a perennial grass, a bacterial cellulose, a seed hull, a recycled cellulose, and any combination thereof.

16. The natural cellulose ester of claim 14, wherein the natural fatty acid is extracted from at least one selected from the group consisting of a vegetable, a seed, corn, flaxseed, hemp, soy, canola, coconut, cocoa, palm, cottonseed, grape seed, almond, peanut, olive, and any combination thereof.

17. The natural cellulose ester of claim 14, wherein the natural cellulose ester has a degree of substitution of about 0.2 to about 3.

18. The natural cellulose ester of claim 14, wherein the natural cellulose ester has a glass transition temperature of about −55° C. to about 170° C.

19. The natural cellulose ester of claim 14, wherein the natural cellulose ester has no true melting temperature.
